(19) United States
(12) Patent Application Publication
(10) Pub. No.: US 2025/0367593 A1
(43) Pub. Date: Dec. 4, 2025

(54) Combined Carbon Dioxide Removal Plant Process

(71) Applicant: Air Products and Chemicals, Inc., Allentown, PA (US)

(72) Inventors: Rameshwar S. Hiwale, Bellaire, TX (US); Michael John Lynch, Macungie, PA (US); David Ross Graham, Harleysville, PA (US); Jay A. Thakkar, Allentown, PA (US)

(73) Assignee: Air Products and Chemicals, Inc., Allentown, PA (US)

(21) Appl. No.: 18/731,913

(22) Filed: Jun. 3, 2024

(51) Int. Cl. B01D 53/14; B01D 53/18; B01D 53/62; B01D 53/78; C01B 3/34; C01B 3/52

(52) U.S. Cl. CPC B01D 53/1475; B01D 53/1425; B01D 53/18; B01D 53/62; B01D 53/78; C01B 3/34; C01B 3/52; B01D 2252/204; B01D 2256/16; B01D 2257/504; B01D 2258/02; C01B 2203/0205; C01B 2203/0415; C01B 2203/0475; C01B 2203/1241; C01B 2203/86

(57) ABSTRACT

A method comprising generating a first process gas stream in a first plant; generating a process heat utility in a second plant; contacting the first process gas stream with a first solvent to produce a first CO2-depleted process gas stream and a first CO2-enriched solvent; regenerating the first CO2-enriched solvent in a regeneration system to produce a CO2-depleted solvent; wherein the process heat utility provides at least a portion of the heating duty for the regeneration system; wherein the first solvent comprises at least a portion of the CO2-depleted solvent.

### BACKGROUND

Industrial processes such as hydrogen production, syngas production, and power generation will need to capture carbon dioxide (CO2) to mitigate the effects of climate change. One such method of carbon capture is absorption in which a solvent such as aqueous amine or activated amine solution is passed countercurrent to the process gas containing CO2. The CO2 absorbed rich solvent is then sent to a CO2 stripping column where the solvent is stripped of CO2 by heating in a reboiler. The heat input to the reboiler could be from a hot process stream or steam. The regenerated lean solvent is returned to the absorber for CO2 absorption.

### SUMMARY

Disclosed herein is an example of a system for capturing CO2 from a process gas stream produced by a first plant using the utilities from a second plant. The system may include an absorber in fluid flow communication with the first plant, configured to contact a solvent with the process gas stream and capture the CO2. The system further includes a regeneration section in fluid flow communication with the first plant and in thermal contact with the second plant to regenerate the solvent.

Disclosed herein is an example of a method for capturing CO2 from a process gas stream produced by a first plant using the utilities from a second plant. The method includes absorbing CO2 from the process gas stream in an absorber to produce a CO2-depleted process gas streams and a CO2-enriched solvent. The method further includes regenerating the CO2-enriched solvent using heat from the second plant in a regeneration section.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

The drawings illustrate certain aspects of some of the embodiments of the present invention and should not be used to limit or define the invention.

FIG. 1 is a schematic view depicting an embodiment of a carbon capture process according to one or more aspects of the present disclosure.

FIG. 2 is a schematic view depicting a modification of FIG. 1 in which two CO2-enriched solvent streams are combined in a shared flash section prior to regeneration.

FIG. 3 is a schematic view depicting a modification of FIG. 1 in which CO2 is captured from one process while a second process provides the heating and/or cooling utilities to the CO2 capture process.

FIG. 4 is a schematic view depicting a modification of FIG. 1 in which two process gas streams are fed to a shared absorber.

### DETAILED DESCRIPTION

The present disclosure is directed to methods and systems for absorbing CO2 into a solvent and regenerating the CO2-enriched solvent using process heat. The methods and systems may include absorbing CO2 from one or more process gas streams in separate absorbers while regenerating the CO2-enriched solvent in a shared regeneration section using heat from one of the plants.

The articles “a” or “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

The term “and/or” placed between a first entity and a second entity includes any of the meanings of (1) only the first entity, (2) only the second entity, or (3) the first entity and the second entity. The term “and/or” placed between the last two entities of a list of 3 or more entities means at least one of the entities in the list including any specific combination of entities in this list. For example, “A, B and/or C” has the same meaning as “A and/or B and/or C” and comprises the following combinations of A, B and C: (1) only A, (2) only B, (3) only C, (4) A and B but not C, (5) A and C but not B, (6) B and C but not A, and (7) A and B and C.

The adjective “any” means one, some, or all, indiscriminately of quantity.

The phrase “at least a portion” means “a portion or all.” The “at least a portion of a stream” has the same composition, with the same concentration of each of the species, as the stream from which it is derived.

As used herein, “first,” “second,” “third,” etc. are used to distinguish among a plurality of steps and/or features, and is not indicative of the total number, or relative position in time and/or space, unless expressly stated as such.

The terms “depleted” or “lean” mean having a lesser mole percent concentration of the indicated component than the original stream from which it was formed. “Depleted” and “lean” do not mean that the stream is completely lacking the indicated component.

The terms “rich” or “enriched” mean having a greater mole percent concentration of the indicated component than the original stream from which it was formed.

“Downstream” and “upstream” refer to the intended flow direction of the process fluid transferred. If the intended flow direction of the process fluid is from the first device to the second device, the second device is downstream of the first device. In case of a recycle stream, downstream and upstream refer to the first pass of the process fluid.

In accordance with the present embodiments, plants may comprise processes such as steam methane reforming (SMR), hydrogen fired SMR, oxy-fuel SMR, partial oxidation, and autothermal reforming that produce a process gas stream comprising hydrogen and CO2. The process gas stream may range in CO2 concentration from 6% to 30% on a volume basis. The process gas stream may range in pressure from 325 psia to 860 psia (22 bara to 60 bara) and from 100° F. to 130° F. (37° C. to 55° C.). Plants may also produce a useful process heating utility that may be used to regenerate the CO2-enriched solvent via steam, a hot process gas stream, hot flue gas stream, waste heat stream, hot compressor outlet steam, or hot heat transfer fluid. One of the plants may be selected to provide the process heating utility to regenerate the CO2-enriched solvent for multiple absorbers in a shared regeneration section. The plant may be selected because it produces more excess heat, for example partial oxidation as compared to steam methane reforming. The plant may be selected for economic reasons, for example a plant with low or no customers for steam compared to a process with high customer demand for steam. The plant may be selected due to design constraints, for example a new build plant that can be designed to produce additional heat for the CO2 capture section as opposed to an existing plant that would require a costly retrofit to produce more heat.

The regeneration section may comprise any combination of stripping columns, flashes, valves, pumps, separators pots, and heat exchangers. Stripping columns may comprise one or more stages of trays and/or packing. Stripping columns may operate at a pressure ranging from 40 kPa to 250 kPa, or from 100 kPa to 170 kPa, and at a temperature ranging from 90° C. to 135° C., or from 90° C. to 110° C. Stripping columns may comprise two or more sections in which the CO2-enriched solvent first undergoes bulk CO2 removal in a first section to produce a partially CO2-depleted solvent and then undergoes final CO2 removal in a second section to produce a CO2-depleted solvent. In some embodiments the first and second sections may comprise a single column in which a portion of the partially CO2-depleted solvent may be withdrawn via a side draw. Regeneration heat exchangers may be used as a reboiler for a stripping column, a preheater upstream of a flash, or a heater integrated with a flash.

The CO2-enriched solvent streams from different absorbers may be at the same or different CO2 concentrations and/or pressures. The CO2-enriched solvent may be at near ambient pressure for some applications or may be at a high pressure ranging from 10 to 80 bara, from 20 to 70 bara, or from 25 to 40 bara that may be let down in pressure in one or more stages, for example a flash at a pressure ranging from 5 bara to 15 bara, with subsequent letdown to a flash or stripper column at a pressure ranging from 1 bara to 3 bara for regeneration. In some cases, the regeneration process may be configured at a pressure above 3 bara. The CO2-enriched solvent may be let down in pressure across a turbine to produce useful work. Pressure reduction may also occur across a flow restriction such as a valve or orifice. The CO2-enriched solvent may also be flashed in a separator to produce an overhead stream and a bottoms stream. The separator may comprise one or more stages of trays and/or packing. The overhead stream may be enriched in light gases such as hydrogen, carbon monoxide, and methane and may be consumed as fuel to provide heat to regenerate the bottoms stream and/or provide heat to the one or more plants. The overhead stream may also be recycled to the process.

The absorbers may be configured to contact the process gas stream with a lean (CO2-depleted) solvent such as amine solutions, activated methyl diethanolamine (aMDEA), monoethanolamine (MEA), diethanolamine (DEA), alkaline hydroxide solutions, aqueous ammonia, potassium carbonate, biphasic solvents, methanol, mixture of dimethyl ethers of polyethylene glycols or ionic liquids. The lean solvent may contrain activators such as piperazine. The lean solvent may be an aqueous solution or may be non-aqueous. The absorbers may comprise one or more stages of trays and/or packing. The absorbers may operate at a pressure ranging from 5 kPa to 8400 kPa, or from 500 kPa to 4000 kPa, and at a temperature ranging from 15° C. to 65° C., or from 25° C. to 50° C. The absorbers may be configured to first contact the process gas stream with a partially CO2-depleted solvent in a bulk absorption section, and then contact the process gas stream with a CO2-depleted solvent in a lean absorption section. When the absorbers comprise a bulk absorption section and a lean absorption section, the sections may comprise separate columns or a single column. The partially CO2-depleted solvent may be obtained from the regeneration system by removing a solvent stream from an intermediate stage of regeneration, and/or a side draw from a single stage of regeneration.

One of the plants may provide the cooling utility for the coolers in the two or more absorbers via a process cooling utility such as cooling water. The plant to provide process cooling utility may be selected based on criteria such as which plant has more unit operations that require spare cooling water capacity such as large compressors or air separation units. In some embodiments the plant that provides cooling utility to the coolers may be the same as the plant that provides heating utility to regenerate the CO2-enriched solvent. In other embodiments different plants may provide cooling utility and heating utility to the CO2 capture process. The plant to provide cooling water may also be selected on that basis that it has more land available to site cooling towers.

Heating and/or cooling utilities may be provided by a combination of one or more plants. The balance of utilities provided by the one or more plants may vary over time due to factors such as start-ups, shutdowns, changes in customer demand, changes in CO2 capture requirements, or upgrades at the facilities.

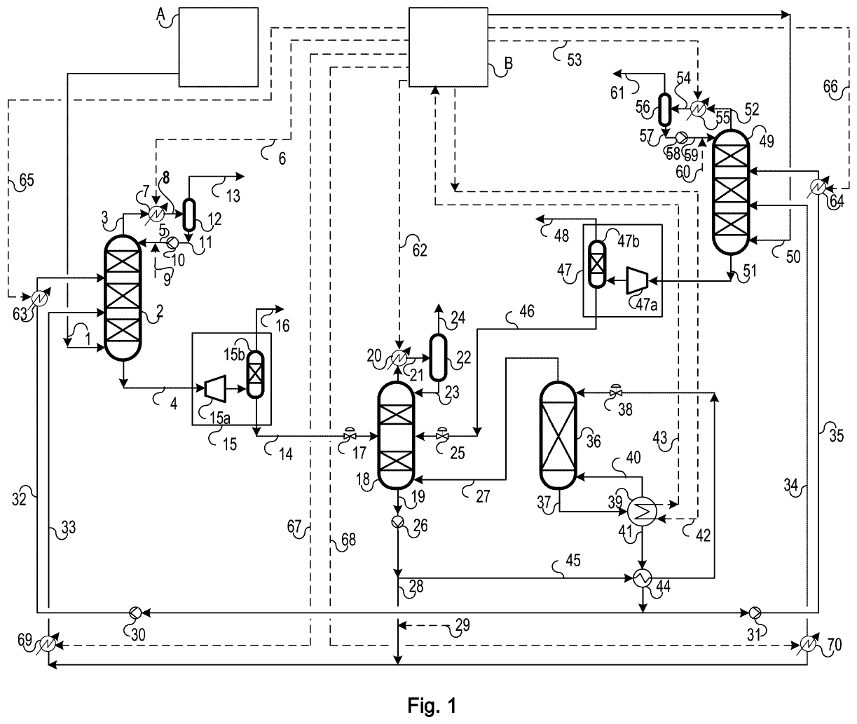

FIG. 1 is a schematic view depicting an embodiment of a carbon capture process according to one or more aspects of the present disclosure. First plant A generates a first process gas stream 1 comprising CO2. First process gas stream 1 enters first absorber 2 and may be contacted with one or more solvent streams with a high affinity for CO2, such as aqueous amine solutions, to produce first CO2-depleted process gas stream 3 and first CO2-enriched solvent 4. In the embodiment shown, first process gas stream 1 is initially contacted with a first partially CO2-depleted solvent 33 for bulk CO2 removal and then contacted with a first solvent 32 for lean CO2 removal, also known as polishing. The first CO2-depleted process gas stream 3 may comprise residual solvent vapor and/or entrained droplets, and so may be contacted with a first wash stream 5 prior to being cooled and partially condensed in first cooler 7. The resulting partially condensed first CO2-depleted process gas stream 8 may then be separated in first condenser separator 12 to form a first condensate stream 11 and a first CO2-depleted product stream 13. First CO2-depleted product stream 13 may be returned to plant A for further processing. If required, the first condensate stream 11 may be pumped in first pump 10 and/or combined with makeup solvent stream 9 to form the first wash stream 5. In some embodiments the makeup solvent stream 9 may comprise makeup water.

First CO2-enriched solvent 4 may be reduced in pressure in first pressure reduction unit 15 prior to regeneration. The first pressure reduction unit 15 may comprise a first turbine 15a to extract useful work from the first CO2-enriched solvent 4. The first pressure reduction unit 15 may comprise a first separator 15b to produce a first bottoms stream 14 and a first overhead stream 16. First bottoms stream 14 may be reduced in pressure across first flow control valve 17 prior to entering first section 18 of a shared stripping column (also known as a low pressure flash) where the first bottoms stream 14 may be contacted with intermediate vapor stream 27. A CO2-enriched gas stream exits the first section 18 and may be cooled in regenerator cooler 20 to partially condense and recover solvent vapor. The partially condensed CO2-enriched gas stream 21 may then be separated in regenerator condenser separator 22 to form a condensate stream 23 that may be returned to the first section 18 and a CO2 gas product stream 24.

Partially CO2-depleted solvent 19 exits the bottom of the first section 18 and may be pumped in pump 26 if required. A portion of the partially CO2-depleted solvent 19 may be divided to form first partially CO2-depleted solvent fraction 45 and second partially CO2-depleted fraction 28. Second partially CO2-depleted fraction 28 may be combined with makeup solvent stream 29 to form the first partially CO2-depleted solvent 33. First partially CO2-depleted solvent 33 may be cooled against first semilean trim cooler 69 if necessary.

First partially CO2-depleted solvent fraction 45 may be heated in heat exchanger 44 and/or reduced in pressure across partially CO2-depleted solvent flow control valve 38 and sent to the second section 36. First partially CO2-depleted solvent fraction 45 may be contacted with reboiler vapor stream 40 to produce CO2-enriched intermediate vapor stream 27 and bottoms stream 37. Bottoms stream 37 may be heated in reboiler exchanger 39 to produce reboiler vapor stream 40 and CO2-depleted solvent 41. CO2-depleted solvent 41 may then be cooled against first partially CO2-depleted solvent fraction 45 in heat exchanger 44 to recover heat prior to pumping if necessary in pump 30 to form first solvent 32. First solvent 32 may be further cooled by first trim cooler 63 if necessary.

Similarly, second plant B generates a second process gas stream 50 comprising CO2. Second process gas stream 50 enters second absorber 49 and may be contacted with one or more solvent streams with a high affinity for CO2, such as aqueous amine solutions, to produce second CO2-depleted process gas stream 52 and second CO2-enriched solvent 51. In the embodiment shown, second process gas stream 50 is initially contacted with a second partially CO2-depleted solvent 34 for bulk CO2 removal and then contacted with a second solvent 35 for lean CO2 removal, also known as polishing. The second CO2-depleted process gas stream 52 may comprise residual solvent vapor and/or entrained droplets, and so may be contacted with a second wash stream 59 prior to being cooled and partially condensed in second cooler 55. The resulting partially condensed second CO2-depleted process gas stream 54 may then be separated in second condenser separator 56 to form a second condensate stream 57 and a second CO2-depleted product stream 61. If required, the second condensate stream 57 may be pumped in second pump 58 and/or combined with makeup solvent stream 60 to form the second wash stream 59. In some embodiments the makeup solvent stream 60 may comprise makeup water.

Second CO2-enriched solvent 51 may be reduced in pressure in second pressure reduction unit 47 prior to regeneration. The second pressure reduction unit 47 may comprise a second turbine 47a to extract useful work from second CO2-enriched solvent 51. The second pressure reduction unit 47 may comprise a second separator 47b to produce a second bottoms stream 46 and a second overhead stream 48. Second bottoms stream 46 may be reduced in pressure across second flow control valve 25 prior to entering first section 18 of the shared stripping column. The second bottoms stream 46 may enter the shared stripping column at a higher or lower stage than the first bottoms stream 14 if the CO2 concentrations of the two streams are significantly different.

A portion of second partially CO2-depleted fraction 28 may be divided to form the second partially CO2-depleted solvent 34. If required by the process, second partially CO2-depleted solvent 34 may be withdrawn from a higher or lower section of the shared stripping column. Second partially CO2-depleted solvent 34 may be cooled in second semilean trim cooler 70 if necessary. First semilean trim cooler 69 and second semilean trim cooler 70 may be combined into a single heat exchanger (not shown) on second partially CO2-depleted fraction 28. A portion of CO2-depleted stream 41 may be divided and pumped if necessary in pump 31 to form second solvent 35. Second solvent 35 may be further cooled by second trim cooler 64 if necessary. First trim cooler 63 and second trim cooler 64 may be combined into a single heat exchanger (not shown) on the CO2-depleted solvent exiting heat exchanger 44.

Plant B may provide heating and cooling utilities for absorbing CO2 and regenerating solvent. This may include any combination of the following: process heating utility 42 to reboiler exchanger 39, first process cooling utility 6 to first cooler 7, second process cooling utility 53 to second cooler 55, third process cooling utility 62 to CO2 cooler 20, fourth process cooling utility 65 to first trim cooler 63, fifth process cooling utility 66 to second trim cooler 64, sixth process cooling utility 67 to first semilean trim cooler 69, and seventh process cooling utility 68 to second semilean trim cooler 70. Plant B may also provide electrical power to devices such as pumps.

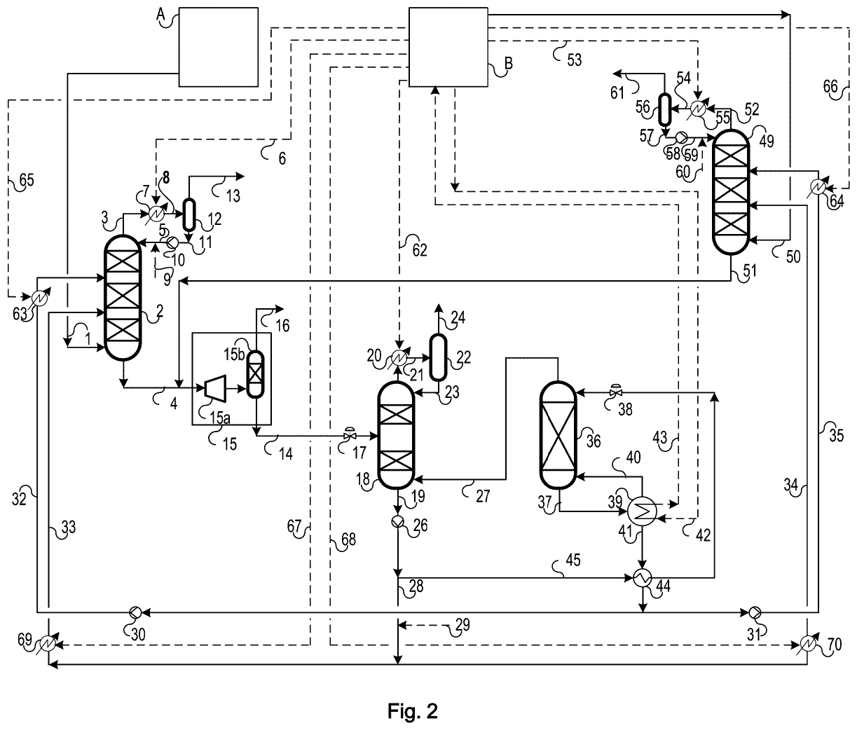

FIG. 2 is a schematic view depicting a modification of FIG. 1 in which two CO2-enriched solvent streams are combined in a shared flash section prior to regeneration. This eliminates the need for second pressure reduction unit 47 and may be particularly useful when first CO2-enriched solvent 4 and second CO2-enriched solvent 51 are at similar pressure and/or CO2 concentration. A pressure reducer such as a valve or orifice may be placed on first CO2-enriched solvent 4 or second CO2-enriched solvent 51 prior to combining if needed (not shown).

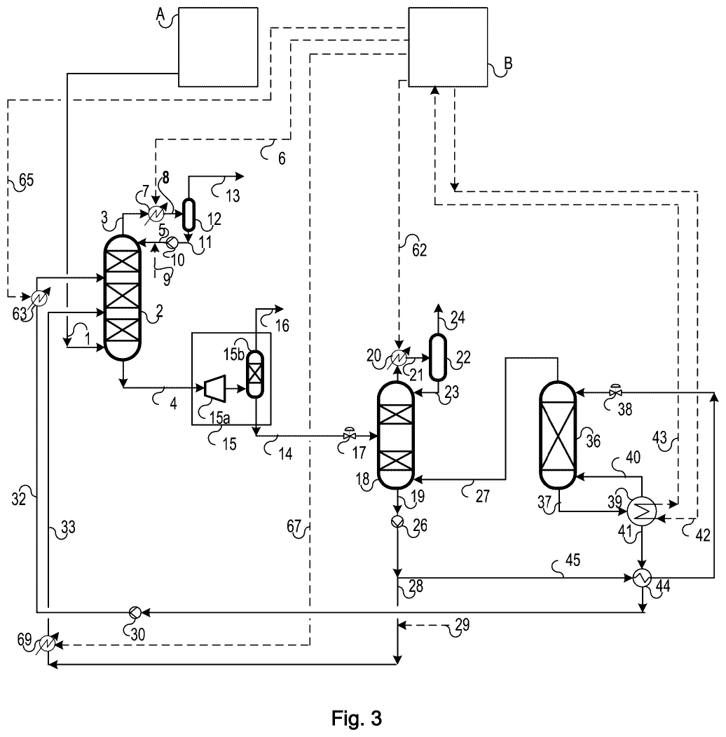

FIG. 3 is a schematic view depicting a modification of FIG. 1 in which CO2 may be captured from one process while a second process provides heating and/or cooling utilities to the CO2 capture process. CO2 may be captured from first process gas stream 1 while the process heating and cooling utilities are provided by second plant B. This arrangement may be desirable when second plant B does not produce a process gas stream with CO2 suitable for capture (such as too low of a concentration or flow rate of CO2) but does have excess heating and/or cooling utilities.

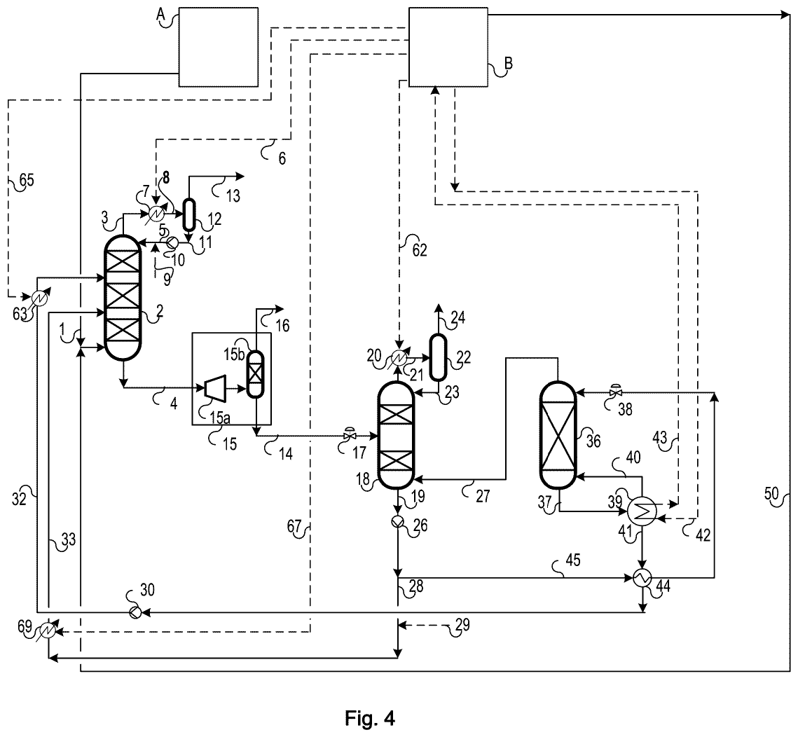

FIG. 4 is a schematic view depicting a modification of FIG. 1 in which two process gas streams are fed to a shared absorber. First process gas stream 1 and second process gas stream 50 are combined and fed to first absorber 2. This arrangement may be advantageous when the composition and pressure of the process gas streams are similar and when the combined flow rate of the process gas streams may be managed by a single absorber column without exceeding column diameter constraints. In the case where the CO2 concentrations in first process gas stream 1 and second process gas stream 50 are significantly different, the streams may be fed to different stages of the first absorber 2.

Aspect 1: A method comprising generating a first process gas stream in a first plant; generating a process heat utility in a second plant; contacting the first process gas stream with a first solvent to produce a first CO2-depleted process gas stream and a first CO2-enriched solvent; regenerating the first CO2-enriched solvent in a regeneration system to produce a CO2-depleted solvent; wherein the process heat utility provides at least a portion of the heating duty for the regeneration system; wherein the first solvent comprises at least a portion of the CO2-depleted solvent.

Aspect 2: A method according to Aspect 1, further comprising generating a second process gas stream in the second plant; contacting the second process gas stream with a second solvent to produce a second CO2-depleted process gas stream and a second CO2-enriched solvent; and regenerating the second CO2-enriched solvent in the regeneration system; wherein the second solvent comprises at least a portion of the CO2-depleted solvent.

Aspect 3: A method according to Aspect 2, wherein the CO2 concentration of the first CO2-enriched solvent is not equal to the CO2 concentration of the second CO2-enriched solvent.

Aspect 4: A method according to any of Aspects 1 to 3, further comprising withdrawing a partially CO2-depleted solvent from the regeneration system; contacting the first process gas stream with at least a portion of the partially CO2-depleted solvent; contacting the second process gas stream with at least a portion of the partially CO2-depleted solvent.

Aspect 5: A method according to any of Aspects 1 to 4, further comprising cooling the first CO2-depleted process gas stream against at least a portion of a process cooling utility; wherein the second plant further generates the process cooling utility.

Aspect 6: A method according to any of Aspects 2 to 5, further comprising cooling the second CO2-depleted process gas stream against at least a portion of a process cooling utility; wherein the second plant further generates the process cooling utility.

Aspect 7: A method according to any of Aspects 1 to 6, further comprising cooling the first CO2-depleted process gas stream against at least a portion of a process cooling utility; wherein the first plant further generates the process cooling utility.

Aspect 8: A method according to any of Aspects 2 to 7, further comprising cooling the second CO2-depleted process gas stream against at least a portion of a process cooling utility; wherein the first plant further generates the process cooling utility.

Aspect 9: A method according to any of Aspects 1 to 8, further comprising reducing the pressure of the first CO2-enriched solvent stream to produce useful work.

Aspect 10: A method according to Aspect 9, wherein the pressure of the first CO2-enriched solvent stream is reduced from a pressure ranging from 20 to 70 bara to a pressure ranging from 5 to 15 bara.

Aspect 11: A method according to any of Aspects 2 to 10, further comprising combining the first CO2-enriched solvent stream with the second CO2-enriched solvent stream to form a combined CO2-enriched solvent stream; and reducing the pressure of the combined CO2-enriched solvent stream to produce useful work.

Aspect 12: A method comprising generating a first process gas stream in a steam methane reforming plant; generating a second process gas stream and a process heat utility in a partial oxidation plant; contacting the first process gas stream with a first solvent to produce a first CO2-depleted process gas stream and a first CO2-enriched solvent; contacting the second process gas stream with a second solvent to produce a second CO2-depleted process gas stream and a second CO2-enriched solvent; regenerating the first CO2-enriched solvent and the second CO2-enriched solvent in a regeneration system to produce a CO2-depleted solvent; wherein the process heat utility provides at least a portion of the heating duty for the regeneration system; wherein the first solvent comprises at least a portion of the CO2-depleted solvent; wherein the second solvent comprises at least a portion of the CO2-depleted solvent.

Aspect 13: A method according to Aspect 12, further comprising withdrawing a partially CO2-depleted solvent from the regeneration system; contacting the first process gas stream with at least a portion of the partially CO2-depleted solvent; contacting the second process gas stream with at least a portion of the partially CO2-depleted solvent.

Aspect 14: A system comprising a first plant configured to produce a first process gas stream; a second plant configured to produce a process heat utility; a first absorber in fluid flow communication with the first plant and configured to contact a first solvent with the first process gas stream to produce a first CO2-depleted process gas stream and a first CO2-enriched solvent; a regeneration system in fluid flow communication with the first absorber configured to regenerate the first CO2-enriched solvent and and produce a CO2-depleted solvent; a regeneration heat exchanger in fluid flow communication with the regeneration system and in thermal contact with the process heat utility; wherein the first solvent comprises at least a portion of the CO2-depleted solvent.

Aspect 15: A system according to Aspect 14, further comprising a second absorber in fluid flow communication with the second plant and configured to contact a second solvent with a second process gas stream to produce a second CO2-depleted process gas stream and a second CO2-enriched solvent; wherein the second plant is further configured to produce the second process gas stream; wherein the regeneration system is in fluid flow communication with the second absorber and is further configured to regenerate the second CO2-enriched solvent; wherein the second solvent comprises at least a portion of the CO2-depleted solvent.

Aspect 16: A system according to Aspect 14 or Aspect 15, wherein the regeneration system is configured to produce a partially CO2-depleted solvent; wherein the first absorber comprises a first lean absorption section and a first bulk absorption section; wherein the second absorber comprises a second lean absorption section and a second bulk absorption section; wherein the first bulk absorption section is configured to accept at least a portion of the partially CO2-depleted solvent; wherein the second bulk absorption section is configured to accept at least a portion of the partially CO2-depleted solvent.

Aspect 17: A system according to any of Aspects 14 to 16, wherein the second plant is configured to further produce a process cooling utility; wherein the first absorber comprises a first cooler in thermal contact with the process cooling utility.

Aspect 18: A system according any of Aspects 15 to 17, wherein the second plant is configured to further produce a process cooling utility; wherein the second absorber comprises a second cooler in thermal contact with the process cooling utility.

Aspect 19: A system according to any of Aspects 14 to 18, wherein the first plant is configured to further produce a process cooling utility; wherein the first absorber comprises a first cooler in thermal contact with the process cooling utility.

Aspect 20: A system according to any of Aspects 15 to 19, wherein the first plant is configured to further produce a process cooling utility; wherein the second absorber comprises a second cooler in thermal contact with the process cooling utility.

### Example

In this example, Plant A and Plant B are both hydrogen producing systems which export steam to a customer. Both plants employ carbon capture to reduce the environmental impact of the hydrogen production. The table below shows the important flow rates for a prior art system with separate CO2 capture systems and for a system according to the present invention in which the CO2 capture systems are integrated according to FIG. 1. In the case of separate CO2 capture, both plant A and plant B have dedicated amine absorption and regeneration systems. In the case of integrated CO2 capture, each plant has a dedicated absorption system that share a common regeneration system. In the integrated CO2 capture case, the regeneration heat requirement is provided by waste heat available from plant B. The results in the table show that the quantity of steam available for export to the customer from Plant B is higher compared to the separate CO2 capture case. The higher total quantity of steam available for export in the integrated CO2 capture case illustrates a key benefit of the present invention.

| | Separate CO2 | Integrated CO2 |
|---|---|---|
| | capture | capture |
| Plant A hydrogen production, tonne/hr | 10 | 10 |
| Plant B hydrogen production, tonne/hr | 15 | 15 |
| Plant A carbon dioxide captured, | 60 | 60 |
| tonne/hr | | |
| Plant B carbon dioxide captured, | 90 | 90 |
| tonne/hr | | |
| Plant A export steam, klbs/hr | 78 | 150 |
| Plant B export steam, klbs/hr | 225 | 225 |

While the principles of the invention have been described above in connection with preferred embodiments, it is to be clearly understood that this description is made only by way of example and not as a limitation of the scope of the invention.

1. A method comprising:
generating a first process gas stream in a first plant;
generating a process heat utility in a second plant;
contacting the first process gas stream with a first solvent to produce a first CO2-depleted process gas stream and a first CO2-enriched solvent;
regenerating the first CO2-enriched solvent in a regeneration system to produce a CO2-depleted solvent;
wherein the process heat utility provides at least a portion of the heating duty for the regeneration system;
wherein the first solvent comprises at least a portion of the CO2-depleted solvent.

2. The method of claim 1, further comprising generating a second process gas stream in the second plant;
contacting the second process gas stream with a second solvent to produce a second CO2-depleted process gas stream and a second CO2-enriched solvent; and
regenerating the second CO2-enriched solvent in the regeneration system;
wherein the second solvent comprises at least a portion of the CO2-depleted solvent.

3. The method of claim 2, wherein the CO2 concentration of the first CO2-enriched solvent is not equal to the CO2 concentration of the second CO2-enriched solvent.

4. The method of claim 1, further comprising withdrawing a partially CO2-depleted solvent from the regeneration system;
contacting the first process gas stream with at least a portion of the partially CO2-depleted solvent;
contacting the second process gas stream with at least a portion of the partially CO2-depleted solvent.

5. The method of claim 1, further comprising cooling the first CO2-depleted process gas stream against at least a portion of a process cooling utility;
wherein the second plant further generates the process cooling utility.

6. The method of claim 2, further comprising cooling the second CO2-depleted process gas stream against at least a portion of a process cooling utility;
wherein the second plant further generates the process cooling utility.

7. The method of claim 1, further comprising cooling the first CO2-depleted process gas stream against at least a portion of a process cooling utility;
wherein the first plant further generates the process cooling utility.

8. The method of claim 2, further comprising cooling the second CO2-depleted process gas stream against at least a portion of a process cooling utility;
wherein the first plant further generates the process cooling utility.

9. The method of claim 1, further comprising reducing the pressure of the first CO2-enriched solvent stream to produce useful work.

10. The method of claim 9, wherein the pressure of the first CO2-enriched solvent stream is reduced from a pressure ranging from 20 to 70 bara to a pressure ranging from 5 to 15 bara.

11. The method of claim 2, further comprising combining the first CO2-enriched solvent stream with the second CO2-enriched solvent stream to form a combined CO2-enriched solvent stream; and
reducing the pressure of the combined CO2-enriched solvent stream to produce useful work.

12. A method comprising:
generating a first process gas stream in a steam methane reforming plant;
generating a second process gas stream and a process heat utility in a partial oxidation plant;
contacting the first process gas stream with a first solvent to produce a first CO2-depleted process gas stream and a first CO2-enriched solvent;
contacting the second process gas stream with a second solvent to produce a second CO2-depleted process gas stream and a second CO2-enriched solvent;
regenerating the first CO2-enriched solvent and the second CO2-enriched solvent in a regeneration system to produce a CO2-depleted solvent;
wherein the process heat utility provides at least a portion of the heating duty for the regeneration system;
wherein the first solvent comprises at least a portion of the CO2-depleted solvent;
wherein the second solvent comprises at least a portion of the CO2-depleted solvent.

13. The method of claim 12, further comprising withdrawing a partially CO2-depleted solvent from the regeneration system;
contacting the first process gas stream with at least a portion of the partially CO2-depleted solvent;
contacting the second process gas stream with at least a portion of the partially CO2-depleted solvent.

14. A system comprising:
a first plant configured to produce a first process gas stream;
a second plant configured to produce a process heat utility;
a first absorber in fluid flow communication with the first plant and configured to contact a first solvent with the first process gas stream to produce a first CO2-depleted process gas stream and a first CO2-enriched solvent;
a regeneration system in fluid flow communication with the first absorber configured to regenerate the first CO2-enriched solvent and and produce a CO2-depleted solvent;
a regeneration heat exchanger in fluid flow communication with the regeneration system and in thermal contact with the process heat utility;
wherein the first solvent comprises at least a portion of the CO2-depleted solvent.

15. The system of claim 14, further comprising a second absorber in fluid flow communication with the second plant and configured to contact a second solvent with a second process gas stream to produce a second CO2-depleted process gas stream and a second CO2-enriched solvent;
wherein the second plant is further configured to produce the second process gas stream;
wherein the regeneration system is in fluid flow communication with the second absorber and is further configured to regenerate the second CO2-enriched solvent;
wherein the second solvent comprises at least a portion of the CO2-depleted solvent.

16. The system of claim 14, wherein the regeneration system is configured to produce a partially CO2-depleted solvent;
wherein the first absorber comprises a first lean absorption section and a first bulk absorption section;
wherein the second absorber comprises a second lean absorption section and a second bulk absorption section;
wherein the first bulk absorption section is configured to accept at least a portion of the partially CO2-depleted solvent;
wherein the second bulk absorption section is configured to accept at least a portion of the partially CO2-depleted solvent.

17. The system of claim 14, wherein the second plant is configured to further produce a process cooling utility;
wherein the first absorber comprises a first cooler in thermal contact with the process cooling utility.

18. The system of claim 15, wherein the second plant is configured to further produce a process cooling utility;
wherein the second absorber comprises a second cooler in thermal contact with the process cooling utility.

19. The system of claim 14, wherein the first plant is configured to further produce a process cooling utility;
wherein the first absorber comprises a first cooler in thermal contact with the process cooling utility.

20. The system of claim 15, wherein the first plant is configured to further produce a process cooling utility;
wherein the second absorber comprises a second cooler in thermal contact with the process cooling utility.
